(19) United States
(12) Patent Application Publication
(10) Pub. No.: US 2023/0287548 A1
(43) Pub. Date: Sep. 14, 2023

(54) Cold rolled, annealed and tempered steel sheet and method of manufacturing the same

(71) Applicant: ArcelorMittal, Luxembourg (LU)

(72) Inventors: Astrid PERLADE, Le Ban-Saint-Martin (FR); Kangying ZHU, Metz (FR); Coralie JUNG, Metz (FR); Michael STOLTZ, Maizières-Lès-Metz Cedex (FR)

(21) Appl. No.: 18/016,799

(22) PCT Filed: Jul. 12, 2021
(86) PCT No.: PCT/IB2021/056244

§ 371 Date: Jan. 18, 2023

(30) Foreign Application Priority Data
Jul. 24, 2020 (WO) PCT/IB2020/057004

(51) Int. Cl. C22C 38/38; C22C 38/32; C22C 38/28; C22C 38/26; C22C 38/22; C22C 38/14; C22C 38/12; C22C 38/06; C22C 38/04; C22C 38/02; C22C 38/00; C21D 9/46; C21D 8/02; C21D 6/00

(52) U.S. Cl. CPC C22C 38/38; C22C 38/32; C22C 38/28; C22C 38/26; C22C 38/22; C22C 38/14; C22C 38/12; C22C 38/06; C22C 38/04; C22C 38/02; C22C 38/002; C22C 38/001; C21D 9/46; C21D 8/0205; C21D 8/0226; C21D 8/0263; C21D 6/005; C21D 6/008; C21D 2211/005; C21D 2211/001; C21D 2211/008; C21D 2211/004

(57) ABSTRACT

A cold rolled, annealed and tempered steel sheet, made of a steel having a composition including, by weight percent: C: 0.03-0.18%, Mn: 6.0-11.0%, Al: <3%, Mo: 0.05-0.5%, B: 0.0005-0.005%, S≤0.010%, P≤0.020%, N≤0.008%, and optionally one or more of the following elements, in weight percentage: Si≤1.20%, Ti≤0.050%, Nb≤0.050%, Cr≤0.5%, V≤0.2%, the remainder of the composition being iron and unavoidable impurities resulting from the smelting, the steel sheet having a microstructure including, in surface fraction, from 0% to 30% of ferrite, such ferrite having a grain size below 1.0 μm, from 3% to 30% of retained austenite, from 40 to 95% of tempered martensite less than 5% of fresh martensite, a carbon [C]_{A} and manganese [Mn]_{A} content in austenite, expressed in weight percent, such that the ratio ([C]_{A}²×[Mn]_{A})/(C %²×Mn %) is below 7.80, C % and Mn % being the nominal values in carbon and manganese in weight %.

The present invention relates to a high strength steel sheet having good weldability properties and to a method to obtain such steel sheet.

### BACKGROUND

To manufacture various items such as parts of body structural members and body panels for automotive vehicles, it is known to use sheets made of DP (Dual Phase) steels or TRIP (Transformation Induced Plasticity) steels.

### SUMMARY OF THE INVENTION

One of the major challenges in the automotive industry is to decrease the weight of vehicles in order to improve their fuel efficiency in view of the global environmental conservation, without neglecting the safety requirements. To meet these requirements, new high strength steels are continuously developed by the steelmaking industry, to have sheets with improved yield and tensile strengths, and good ductility and formability.

One of the developments made to improve mechanical properties is to increase content of manganese in steels. The presence of manganese helps to increase ductility of steels thanks to the stabilization of austenite. But these steels present weaknesses of brittleness. To overcome this problem, elements as boron are added. These boron-added chemistries are very tough at the hot-rolled stage but the hot band is too hard to be further processed. The most efficient way to soften the hot band is batch annealing, but it leads to a loss of toughness.

In addition to these mechanical requirements, such steel sheets have to show a good resistance to liquid metal embrittlement (LME). Zinc or Zinc-alloy coated steel sheets are very effective for corrosion resistance and are thus widely used in the automotive industry. However, it has been experienced that arc or resistance welding of certain steels can cause the apparition of particular cracks due to a phenomenon called Liquid Metal Embrittlement (“LME”) or Liquid Metal Assisted Cracking (“LMAC”). This phenomenon is characterized by the penetration of liquid Zn along the grain boundaries of underlying steel substrate, under applied stresses or internal stresses resulting from restraint, thermal dilatation or phases transformations. It is known that adding elements like carbon or silicon are detrimental for LME resistance.

The automotive industry usually assesses such resistance by limiting the upper value of a so-called LME index calculated according to the following equation:

LME index=C %+Si %/4,

wherein C % and S % i stands respectively for the nominal weight percentages of carbon and silicon in the steel.

The publication WO2020011638 relates to a method for providing a medium and intermediate manganese (Mn between 3.5 to 12%) cold-rolled steel with a reduced carbon content. Two process routes are described. The first one concerns an intercritical annealing of the cold rolled steel sheet. The second one concerns a double annealing of the cold rolled steel sheet, the first one being fully austenitic, the second one being intercritical. Thanks to the choice of the annealing temperature, a good compromise of tensile strength and elongation is obtained. By lowering annealing temperature an enrichment in austenite is obtained, which implies a good fracture thickness strain value. But the low amount of carbon and manganese used in the invention limits the tensile strength of the steel sheet to values not higher than 980 MPa.

An object of the present invention is to provide a steel sheet having a combination of high mechanical properties with a yield strength above or equal to 1000 MPa, a tensile strength TS above or equal to 1450 MPa, a uniform elongation UE above or equal to 6.5% and a total elongation TE above or equal to 9%.

Preferably, the steel sheet according to the invention satisfies TS×TE>13 700 MPa. %.

Preferably, the steel sheet according to the invention has a LME index of less than 0.36.

Preferably, the steel sheet according to the invention has a carbon equivalent Ceq lower than 0.4%, the carbon equivalent being defined as

Ceq=C %+Si %/55+Cr %/20+Mn %/19−Al %/18+2.2P %−3.24B %−0.133*Mn %*Mo %

with elements being expressed by weight percent.

Preferably, the resistance spot weld of two steel parts of the steel sheet according to the invention has an a value of at least 30 daN/mm2.

The present invention provides a cold rolled, annealed and tempered steel sheet, made of a steel having a yield strength YS above or equal to 1000 MPa, and a composition comprising, by weight percent:
C: 0.03-0.18%
Mn: 6.0-11.0%
Mo: 0.05-0.5%
B: 0.0005-0.005%
S≤0.010%
P≤0.020%
N≤0.008%
and comprising optionally one or more of the following elements, in weight percentage:
Al<3%
Si≤1.20%
Ti≤0.050%
Nb≤0.050%
Cr≤0.5%
V≤0.2%
the remainder of the composition being iron and unavoidable impurities resulting from the smelting,
said steel sheet having a microstructure comprising, in surface fraction,
from 0% to 30% of ferrite, such ferrite having a grain size below 1.0 μm,
from 3% to 30% of retained austenite,
from 40 to 95% of tempered martensite
less than 5% of fresh martensite,
a carbon [C]_{A} and manganese [Mn]_{A} content in austenite, expressed in weight percent, such that the ratio ([C]_{A}²×[Mn]_{A})/(C %²×Mn %) is below 7.80, C % and Mn % being the nominal values in carbon and manganese in weight %.

### BRIEF DESCRIPTION OF THE DRAWINGS

FIG. 1 represents a section of the hot rolled and heat-treated steel sheet of trial 4 and trial 28.

FIG. 2 shows the plotted curve for trial 4 and trial 28 of accumulated area fraction with respect to Mn content.

### DETAILED DESCRIPTION

The invention will now be described in detail and illustrated by examples without introducing limitations.

According to the invention the carbon content is from 0.03% to 0.18% to ensure a satisfactory strength and good weldability properties. Above 0.18% of carbon, weldability of the steel sheet and the resistance to LME may be reduced. The temperature of the soaking depends on carbon content: the higher the carbon content, the lower the soaking temperature to stabilize austenite. If the carbon content is lower than 0.03%, The strength of the tempered martensite is not sufficient to get UTS above 1450 MPa. In a preferred embodiment of the invention, the carbon content is from 0.05% to 0.15%. In another preferred embodiment of the invention, the carbon content is from 0.08 to 0.12%.

The manganese content is from 6.0% to 11.0%. Above 11.0% of addition, weldability of the steel sheet may be reduced, and the productivity of parts assembly can be reduced. Moreover, the risk of central segregation increases to the detriment of the mechanical properties. As the temperature of soaking depends on manganese content too, the minimum of manganese is defined to stabilize austenite, to obtain, after soaking, the targeted microstructure and strengths. Preferably, the manganese content is from 6.0% to 9%.

According to the invention, aluminium content is below 3% to decrease the manganese segregation during casting. Aluminium is a very effective element for deoxidizing the steel in the liquid phase during elaboration. Above 3% of addition, the weldability of the steel sheet may be reduced, so as castability. Moreover, tensile strength above 1450 MPa is difficult to achieve. Moreover, the higher the aluminium content, the higher the soaking temperature to stabilize austenite. Aluminium is preferably added at least up to 0.2% to improve product robustness by enlarging the intercritical range, and to improve weldability. Moreover, aluminium can be added to avoid the occurrence of inclusions and oxidation problems. In a preferred embodiment of the invention, the aluminium content is from 0.2% to 2.2%.

The molybdenum content is from 0.05% to 0.5% to decrease the manganese segregation during casting. Moreover, an addition of at least 0.05% of molybdenum provides resistance to brittleness. Above 0.5%, the addition of molybdenum is costly and ineffective in view of the properties which are required. In a preferred embodiment of the invention, the molybdenum content is from 0.15% to 0.35%.

According to the invention, the boron content is from 0.0005% to 0.005% to improve the toughness of the hot rolled steel sheet and the spot weldability of the cold rolled steel sheet. Above 0.005%, the formation of boro-carbides at the prior austenite grain boundaries is promoted, making the steel more brittle. In a preferred embodiment of the invention, the boron content is from 0.001% to 0.003%.

Optionally some elements can be added to the composition of the steel according to the invention.

The maximum addition of silicon content is limited to 1.20% to improve LME resistance. In addition, this low silicon content makes it possible to simplify the process by eliminating the step of pickling the hot rolled steel sheet before the hot band annealing. Preferably the maximum silicon content added is 0.5%.

Titanium can be added up to 0.050% to provide precipitation strengthening. Preferably, a minimum of 0.010% of titanium is added in addition of boron to protect boron against the formation of BN.

Niobium can optionally be added up to 0.050% to refine the austenite grains during hot-rolling and to provide precipitation strengthening. Preferably, the minimum amount of niobium added is 0.010%.

Chromium and vanadium can optionally be respectively added up to 0.5% and 0.2% to provide improved strength.

The remainder of the composition of the steel is iron and impurities resulting from the smelting. In this respect, P, S and N at least are considered as residual elements which are unavoidable impurities. Their content is less than or equal to 0.010% for S, less than or equal to 0.020% for P and less than or equal to 0.008% for N.

The microstructure of the steel sheet according to the invention will now be described. It contains, in surface fraction:
from 0% to 30% of ferrite, such ferrite having a grain size below 1.0 μm,
from 3% to 30% of retained austenite,
from 40 to 95% of tempered martensite
less than 5% of fresh martensite,
a carbon [C]_{A} and manganese [Mn]_{A} content in austenite, expressed in weight percent, such that the ratio ([C]_{A}²×[Mn]_{A})/(C %²×Mn %) is below 7.80, C % and Mn % being the nominal values in carbon and manganese in weight %.

The microstructure of the steel sheet according to the invention contains from 3% to 30% of retained austenite. Below 3% or above 30% of austenite, the uniform and total elongations UE and TE can not reach the respective minimum values of 6.5% and 9%.

Such austenite is formed during the intercritical annealing of the hot-rolled steel sheet but also during the annealing of the cold rolled steel sheet. During the intercritical annealing of the hot rolled steel sheet, areas containing a manganese content higher than nominal value and areas containing manganese content lower than nominal value are formed, creating a heterogeneous distribution of manganese. Carbon co-segregates with manganese accordingly. This manganese heterogeneity is measured thanks to the slope of manganese distribution for the hot rolled steel sheet, which must be above or equal to −30, as shown on FIG. 2 and explained later.

The carbon [C]_{A} and manganese [Mn]_{A} contents in austenite, expressed in weight percent, are such that the ratio ([C]_{A}²×[Mn]_{A})/(C %²×Mn %) is below 7.80, C % and Mn % being the nominal values in carbon and manganese in weight %. When the ratio is above 7.80, the retained austenite is too stable to provide a sufficient TRIP-TWIP effect during deformation. Such TWIP-TRIP effect is notably explained in “Observation-of-the-TWIP-TRIP-Plasticity-Enhancement-Mechanism-in-Al-Added-6-Wt-Pct-Medium-Mn-Steel”, DOI: 10.1007/s11661-015-2854-z, The Minerals, Metals & Materials Society and ASM International 2015, p. 2356 Volume 46A, June 2015 (S. LEE, K. LEE, and B. C. DE COOMAN).

The microstructure of the steel sheet according to the invention contains from 0 to 30% of ferrite such ferrite having a grain size below 1.0 μm. Such ferrite can be formed during the annealing of the cold rolled steel sheet, when it takes place at a temperature from Ac1 to Ac3 of the cold rolled steel sheet. When the annealing of the cold rolled steel sheet takes place above Ac3 of the cold rolled steel sheet, no ferrite is present. Preferably the ferrite content is comprised from 0% to 25%.

The microstructure of the steel sheet according to the invention contains from 40 to 95% of tempered martensite. Such martensite can be formed upon cooling after the intercritical annealing of the hot-rolled steel sheet, by transformation of a part of austenite, that is less rich in carbon and martensite than the nominal values. But it is mostly formed upon cooling after the annealing of the cold rolled steel sheet and then gets tempered during the tempering of the cold rolled steel sheet.

Fresh martensite can be present up to 5% in surface fraction but is not a phase that is desired in the microstructure of the steel sheet according to the invention. It can be formed during the final cooling step to room temperature by transformation of unstable austenite. Indeed, this unstable austenite with low carbon and manganese contents leads to a martensite start temperature Ms above 20° C. To obtain the final mechanical properties, the fresh martensite is limited to a maximum of 5% and preferably below 2% or even better reduced down to 0%.

Tempered martensite can be distinguished from fresh martensite on a section polished and etched with a reagent known per se, for example Nital reagent, observed by Scanning Electron Microscopy (SEM) or on a section polished, analysed by Electron Backscatter Diffraction (EBSD). Tempered martensite has a dislocation density lower than the fresh martensite.

By contrast, the fresh martensite, which results from the transformation of carbon enriched austenite into martensite after the tempering step, has a C content higher than the nominal carbon content of the steel and a dislocation density higher than the tempered martensite.

In a first embodiment, the microstructure comprises from 5% to 25% of ferrite, from 10% to 25% of retained austenite and from 50% to 85% of tempered martensite.

In another embodiment, the microstructure comprises no ferrite, from 5% to 15% of retained austenite and from 85% to 95% of tempered martensite.

The steel sheet according to the invention has a yield strength YS above or equal to 1000 MPa, a tensile strength TS above or equal to 1450 MPa, a uniform elongation UE above or equal to 6.5% and a total elongation TE above or equal to 9%.

Preferably, the cold rolled and annealed steel sheet has a LME index below 0.36.

Preferably, the steel sheet has a carbon equivalent Ceq lower than 0.4% to improve weldability. The carbon equivalent is defined as Ceq=C %+Si %/55+Cr %/20+Mn %/19−Al %/18+2.2P %−3.24B %−0.133*Mn %*Mo %, with elements being expressed by weight percent.

A welded assembly can be manufactured by producing two parts out of sheets of steel according to the invention, and then perform resistance spot welding of the two steel parts.

The resistance spot welds joining the first sheet to the second sheet are characterized by a high resistance in cross-tensile test defined by an a value of at least 30 daN/mm2.

The steel sheet according to the invention can be produced by any appropriate manufacturing method and the person skilled in the art can define one. It is however preferred to use the method according to the invention comprising the following steps:

A semi-product able to be further hot-rolled, is provided with the steel composition described above. The semi product is heated to a temperature from 1150° C. to 1300° C., so to make it possible to ease hot rolling, with a final hot rolling temperature FRT from 800° C. to 1000° C. Preferably, the FRT is comprised between 850° C. and 950° C.

The hot-rolled steel is then cooled and coiled at a temperature Tam from 20° C. to 650° C., and preferably from 300 to 500° C.

The hot rolled steel sheet is then cooled to room temperature and can be pickled.

The hot rolled steel sheet is then annealed to an annealing temperature T_{HBA} between Ac1 and Ac3. More precisely, T_{HBA} is chosen to minimize the area fraction of precipitated carbides below 0.8% and to promote manganese inhomogeneous repartition. This manganese heterogeneity is measured thanks to the slope of manganese distribution for the hot rolled steel sheet, which must be above or equal to −30. Preferably, the temperature T_{HBA} is comprised from Ac1+5° C. to Ac3. More preferably the temperature T_{HBA} is from 580° C. to 680° C.

The steel sheet is maintained at said temperature T_{HBA} for a holding time t_{HBA} from 0.1 to 120 h to promote manganese diffusion and formation of inhomogeneous manganese distribution. Moreover, this heat treatment of the hot rolled steel sheet allows decreasing the hardness while maintaining the toughness of the hot-rolled steel sheet.

The hot rolled and heat-treated steel sheet is then cooled to room temperature and can be pickled to remove oxidation.

The hot rolled and heat-treated steel sheet is then cold rolled at a reduction rate from 20% to 80%.

The cold rolled steel sheet is then submitted to an annealing at a temperature Tₛₒₐₖ from T1 to (Ac3+50×C %/0.1) for a holding time tₛₒₐₖ of 10 s to 3600 s, T1 being the temperature at which 30% of ferrite, in surface fraction, is formed at the end of the soaking, Ac3 being determined by dilatometry for the cold rolled steel sheet and C % referring to the nominal concentration in carbon. When Tₛₒₐₖ is higher than this limit, not enough austenite can be stabilized at room temperature. Preferably, Tₛₒₐₖ is from 720 to 860° C. and more preferably from 720° C. to 820° C. and the time tₛₒₐₖ is from 100 to 1000 s. Such annealing can be performed by continuous annealing.

The cold rolled and annealed steel sheet is then quenched below 80° C. and preferably below 50° C. at an average cooling rate of at least 0.1° C./s and preferably of at least 1° C./s. Part of the austenite present at the end of the soaking will be turned into fresh martensite

After quenching, the steel sheet is then submitted to a tempering step at a temperature Tₜₑₘₚₑᵣ for a holding time tₜₑₘₚₑᵣ which are such that (Tₜₑₘₚₑᵣ+273)×(13+log tₜₑₘₚₑᵣ) is from 6000 to 8700, and preferably from 7000 to 8200. Preferably, Tₜₑₘₚₑᵣ is below 300° C. and tₜₑₘₚₑᵣ is from to 100 to 1800 s.

The fresh martensite is transformed into tempered martensite at the end of this tempering step.

The cold rolled, annealed and tempered steel sheet is then cooled to room temperature. It can then be coated by any suitable process including hot-dip coating, electrodeposition or vacuum coating of zinc or zinc-based alloys or of aluminium or aluminium-based alloys.

In another embodiment, the above described process can be stopped after the hot rolled sheet annealing or after the cold rolling or after coating and the corresponding steel sheets can be cut into blanks that will then be used to manufacture parts by press hardening. If the coating occurs by hot dip coating, it is usually preferable to perform an annealing to prepare the surface of the sheet just before dipping it in the hot melt bath.

Such press hardening operation consists in an austenitisation step wherein the steel blank is heated in an oven to a temperature going from T1 to (Ac3+50×C %/0.1), similarly to the annealing described above for the cold rolled steel sheet. Preferably, this austenitisation temperature is from 720 to 860° C. and more preferably from 720° C. to 820° C. and the austenitisation time is from 30 to 1000 s. The heated blank is then transferred to a hot stamping die where the hot stamping takes place.

The part is then maintained into the die while hardening takes place through a quenching operation. The quenching is performed so as to reach a cooling rate of at least 0.1 C/s until reaching the Ms temperature. During this quenching, the part will acquire the same microstructure as the one targeted for the cold rolled and annealed steel sheet.

The steel part is then submitted to a tempering operation that requires to heat the part at a temperature Tₜₑₘₚₑᵣ for a holding time temper which are such that (Tₜₑₘₚₑᵣ+273)×/13+log tₜₑₘₚₑᵣ) is from 6000 to 8700, and preferably from 7000 to 8200. Preferably, Tₜₑₘₚₑᵣ is below 300° C. and tₜₑₘₚₑᵣ is from to 10 to 1800 s. The part will then acquire the same microstructure as the one targeted for the cold rolled, annealed and tempered steel sheet.

Such tempering can advantageously be performed when the steel part is painted, during the bake hardening process that is undertaken for curing the paint.

The invention will be now illustrated by the following examples, which are by no way imitative.

### EXAMPLES

Seven grades, whose compositions are gathered in table 1, were cast in semi-products and processed into steel sheets.

TABLE 1
Compositions

| | | | | | | | | | | | | | Ac1 | Ac3 | Ms | |
|---|---|---|---|---|---|---|---|---|---|---|---|---|---|---|---|---|
| Steel | C | Mn | Al | Mo | B | S | P | N | Si | Nb | Ti | Cr | (° C.) | (° C.) | (° C.) | Ceq |
| A | 0.15 | 7.7 | 0.96 | 0.22 | 0.0028 | 0.002 | 0.012 | 0.003 | 0.02 | 0.018 | — | — | 560 | 820 | 245 | 0.33 |
| B | 0.16 | 7.7 | 0.96 | 0.22 | 0.0028 | 0.002 | 0.012 | 0.002 | 0.809 | 0.018 | — | — | 560 | 830 | 231 | 0.35 |
| C | 0.10 | 7.7 | 0.06 | 0.22 | 0.0044 | 0.002 | 0.013 | 0.035 | 0.32 | 0.026 | — | — | 570 | 740 | 264 | 0.30 |
| D | 0.15 | 7.0 | 0.03 | 0.20 | 0.002 | 0.002 | 0.011 | 0.004 | 0.295 | 0.022 | — | — | 550 | 750 | 263 | 0.35 |
| E | 0.13 | 5.0 | 1.7 | 0.001 | 0.0008 | 0.004 | 0.012 | 0.002 | 0.468 | 0.001 | 0.015 | — | 640 | 960 | 350 | 0.39 |
| F | 0.22 | 2.0 | 0.04 | — | — | 0.002 | 0.009 | 0.005 | 1.48 | — | — | 0.34 | 730 | 835 | 365 | 0.37 |
| G | 0.22 | 1.2 | 0.04 | — | 0.003 | 0.002 | 0.012 | 0.005 | 0.25 | 0.04 | — | 0.18 | 750 | 840 | 408 | 0.30 |

Underlined values: out of the invention

The tested compositions are gathered in the following table wherein the element contents are expressed in weight percent.

Ac1, Ac3 and Ms temperatures of the cold-rolled sheet have been determined through dilatometry tests and metallography analysis.

TABLE 2
Process parameters of the hot rolled and heat-treated steel sheets

| | | Hot rolling | Coiling | Hot band annealing (HBA) | |
|---|---|---|---|---|---|
| Trials | Steel | FRT (° C.) | CT (° C.) | T_{HBA}(° C.) | t_{HBA}(h) |
| 1 | A | 850 | 450 | 640 | 10 |
| 2 | A | 850 | 450 | 640 | 10 |
| 3 | A | 850 | 450 | 640 | 10 |
| 4 | B | 850 | 450 | 630 | 40 |
| 5 | B | 850 | 450 | 630 | 40 |
| 6 | B | 850 | 450 | 630 | 40 |
| 7 | B | 850 | 450 | 630 | 40 |
| 8 | B | 850 | 450 | 630 | 40 |
| 9 | B | 850 | 450 | 630 | 40 |
| 10 | C | 850 | 450 | 640 | 40 |
| 11 | C | 850 | 450 | 640 | 40 |
| 12 | C | 850 | 450 | 640 | 40 |
| 13 | C | 850 | 450 | 640 | 40 |
| 14 | C | 850 | 450 | 640 | 40 |
| 15 | C | 850 | 450 | 640 | 40 |
| 16 | C | 850 | 450 | 640 | 40 |
| 17 | D | 850 | 450 | 650 | 40 |
| 18 | D | 850 | 450 | 650 | 40 |
| 19 | D | 850 | 450 | 650 | 40 |
| 20 | D | 850 | 450 | 650 | 40 |
| 21 | D | 850 | 450 | 650 | 40 |
| 22 | D | 850 | 450 | 650 | 40 |
| 23 | D | 850 | 450 | 650 | 40 |
| 24 | D | 850 | 450 | 650 | 40 |
| 25 | E | 950 | 450 | 600 | 13 |
| 26 | F | 950 | 550 | 550 | 15 |
| 27 | F | 950 | 550 | 550 | 15 |
| 28 | G | 950 | 600 | — | — |

Underlined values: parameters which do not allow to obtain the targeted properties

Steel semi-products, as cast, were reheated at 1200° C., hot rolled and then coiled. The hot rolled and coiled steel sheets are then heat treated at a temperature T_{HBA} and maintained at said temperature for a holding time t_{HBA}. The following specific conditions to obtain the hot rolled and heat-treated steel sheets were applied:

The hot rolled and heat-treated steel sheets were analyzed, and the corresponding properties are gathered in table 3.

TABLE 3
Microstructure and properties of the hot
rolled and heat-treated steel sheet

| | | Area fraction of |
|---|---|---|
| | Slope of the Mn | precipitated carbides |
| Trials | distribution | (%) |
| 1 | −18 | 0.3 |
| 2 | −18 | 0.3 |
| 3 | −18 | 0.3 |
| 4 | −22.4 | 0.6 |
| 5 | −22.4 | 0.6 |
| 6 | −22.4 | 0.6 |
| 7 | −22.4 | 0.6 |
| 8 | −22.4 | 0.6 |
| 9 | −22.4 | 0.6 |
| 10 | −27 | 0 |
| 11 | −27 | 0 |
| 12 | −27 | 0 |
| 13 | −27 | 0 |
| 14 | −27 | 0 |
| 15 | −27 | 0 |
| 16 | −27 | 0 |
| 17 | −28 | 0.2 |
| 18 | −28 | 0.2 |
| 19 | −28 | 0.2 |
| 20 | −28 | 0.2 |
| 21 | −28 | 0.2 |
| 22 | −28 | 0.2 |
| 23 | −28 | 0.2 |
| 24 | −28 | 0.2 |
| 25 | −68 | 1.6 |
| 26 | −68 | 2.7 |
| 27 | −68 | 2.7 |
| 28 | −68 | 2.7 |

Underlined values: do not match the targeted values.

The slope of the manganese distribution and the fraction of precipitated carbides were determined.

The fraction of precipitated carbides is determined thanks to a section of sheet examined through Scanning Electron Microscope with a Field Emission Gun (“FEG-SEM”) and image analysis at a magnification greater than 15000×.

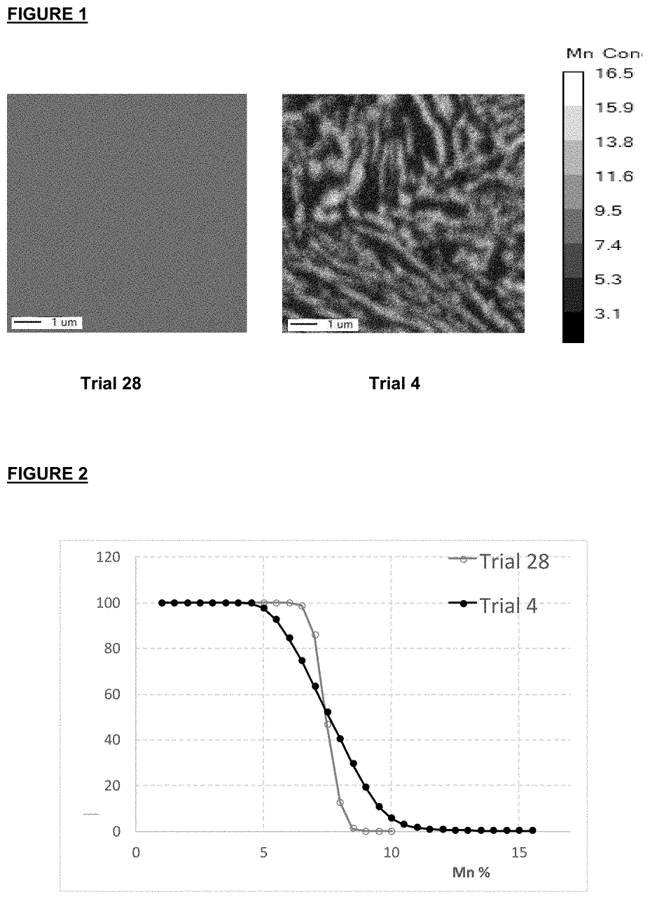

FIG. 1 represents a section of the hot rolled and heat-treated steel sheet of trial 4 and trial 28. The black area corresponds to area with lower amount of manganese, the grey area corresponds to a higher amount of manganese.

This figure is obtained through the following method: a specimen is cut at ¼ thickness from the hot rolled and heat-treated steel sheet and polished.

The section is afterwards characterized through electron probe micro-analyzer, with a Field Emission Gun (“FEG”) at a magnification greater than 10000× to determine the manganese amounts. Three maps of 10 μm*10 μm of different parts of the section were acquired. These maps are composed of pixels of 0.01 μm². Manganese amount in weight percent is calculated in each pixel and is then plotted on a curve representing the accumulated area fraction of the three maps as a function of the manganese amount.

This curve is plotted in FIG. 2 for trial 4 and trial 28: 100% of the sheet section contains more than 1% of manganese. For trial 4, 20% of the sheet section contains more than 9% of manganese.

The slope of the curve obtained is then calculated between the point representing 80% of accumulated area fraction and the point representing 20% of accumulated area fraction.

For trial 28, the absence of heat treatment after hot rolling implies that the repartition of manganese is not heterogeneous enough, which can be seen by the value of the slope of the manganese distribution lower than −30.

On the contrary, for trial 4, the repartition of manganese is clearly non-homogenous, which is evidenced by the value of the slope of the manganese distribution higher than −30.

The heat treatment of the hot rolled steel sheet allows manganese to diffuse in austenite: the repartition of manganese is heterogeneous with areas with low manganese content and areas with high manganese content. This manganese heterogeneity helps to achieve mechanical properties and can be measured thanks to the manganese profile.

TABLE 4
Process parameters of the cold rolled, annealed and tempered steel sheets

| | Cold | Annealing | | Tempering | | (Tₜₑₘₚₑᵣ + 273) × |
|---|---|---|---|---|---|---|
| Trials | rolling (%) | Tₛₒₐₖ(° C.) | tₛₒₐₖ(s) | Tₜₑₘₚₑᵣ(° C.) | tₜₑₘₚₑᵣ(s) | (13 + log tₜₑₘₚₑᵣ) |
| 1 | 50 | 740 | 100 | NA | NA | NA |
| 2 | 50 | 740 | 100 | 170 | 1200 | 7123 |
| 3 | 50 | 760 | 100 | 170 | 1200 | 7123 |
| 4 | 50 | 760 | 120 | 170 | 1200 | 7123 |
| 5 | 50 | 780 | 120 | 170 | 1200 | 7123 |
| 6 | 50 | 800 | 120 | 170 | 1200 | 7123 |
| 7 | 50 | 820 | 120 | 170 | 1200 | 7123 |
| 8 | 50 | 840 | 120 | 170 | 1200 | 7123 |
| 9 | 50 | 860 | 120 | 170 | 1200 | 7123 |
| 10 | 50 | 720 | 120 | 200 | 220 | 7257 |
| 11 | 50 | 740 | 120 | 200 | 220 | 7257 |
| 12 | 50 | 780 | 120 | 200 | 220 | 7257 |
| 13 | 50 | 800 | 120 | 200 | 220 | 7257 |
| 14 | 50 | 760 | 120 | 150 | 220 | 6490 |
| 15 | 50 | 760 | 120 | 250 | 220 | 8024 |
| 16 | 50 | 760 | 120 | 300 | 220 | 8791 |
| 17 | 50 | 720 | 120 | 200 | 220 | 7257 |
| 18 | 50 | 740 | 120 | 200 | 220 | 7257 |
| 19 | 50 | 760 | 120 | 200 | 220 | 7257 |
| 20 | 50 | 780 | 120 | 200 | 220 | 7257 |
| 21 | 50 | 800 | 120 | 200 | 220 | 7257 |
| 22 | 50 | 760 | 120 | 150 | 220 | 6490 |
| 23 | 50 | 760 | 120 | 250 | 220 | 8024 |
| 24 | 50 | 760 | 120 | 300 | 220 | 8791 |
| 25 | 56 | 880 | 120 | 170 | 1200 | 7123 |
| 26 | 52 | 900 | 120 | 170 | 1200 | 7123 |
| 27 | 52 | 900 | 120 | 250 | 300 | 8095 |
| 28 | 50 | 900 | 120 | 170 | 1200 | 7123 |

Underlined values: parameters which do not allow to obtain the targeted properties
NA : not applied

The hot rolled and heat-treated steel sheet obtained are then cold rolled. The cold rolled steel sheet are then first annealed at a temperature Tₛₒₐₖ and maintained at said temperature for a holding time tₛₒₐₖ, before being quenched below 80° C., preferably below 50° C. at a cooling speed of 2° C./s. The steel sheet is then heated a second time at a temperature Tₜₑₘₚₑᵣ and maintained at said temperature for a holding time tₜₑₘₚₑᵣ, before being cooled to room temperature. The following specific conditions to obtain the cold rolled and annealed steel sheets were applied:

The cold rolled, and annealed sheets were then analyzed, and the corresponding microstructure elements, mechanical properties and weldability properties were respectively gathered in table 5, 6 and 7.

TABLE 5
Microstructure of the cold rolled, annealed and tempered steel sheet

| | Ferrite | Ferrite | Residual | [C]_{A} | [Mn]_{A} | [C]_{A}² × [Mn]_{A}/ | Tempered | Fresh |
|---|---|---|---|---|---|---|---|---|
| Trials | (%) | size (μm) | austenite (%) | (% wt) | (% wt) | C %² × Mn % | martensite (%) | martensite (%) |
| 1 | 25 | 0.8 | 25.0 | 0.18 | 10.0 | 1.84 | 0 | 50.0 |
| 2 | 25 | 0.8 | 25.0 | 0.21 | 10.0 | 2.51 | 50.0 | 0 |
| 3 | 15 | 0.8 | 20.0 | 0.28 | 9.9 | 4.42 | 65.0 | 0 |
| 4 | 15 | 0.9 | 24.8 | 0.25 | 9.6 | 3.22 | 60.2 | 0 |
| 5 | 10 | 0.9 | 20.6 | 0.26 | 9.5 | 3.45 | 69.4 | 0 |
| 6 | 7 | 0.8 | 14.9 | 0.30 | 9.4 | 4.54 | 78.1 | 0 |
| 7 | 5 | 0.8 | 9.9 | 0.31 | 9.3 | 4.79 | 85.1 | 0 |
| 8 | 0 | — | 8.4 | 0.34 | 9.3 | 5.77 | 91.6 | 0 |
| 9 | 0 | — | 6.2 | 0.35 | 9.3 | 6.11 | 93.8 | 0 |
| 10 | 15 | 0.9 | 20.0 | 0.16 | 9.6 | 3.31 | 65.0 | 0 |
| 11 | 3 | 0.8 | 15.2 | 0.18 | 9.6 | 4.19 | 81.8 | 0 |
| 12 | 0 | — | 10.0 | 0.20 | 9.4 | 5.07 | 90.0 | 0 |
| 13 | 0 | — | 8.0 | 0.25 | 9.3 | 7.84 | 92.0 | 0 |
| 14 | 0 | — | 11.0 | 0.18 | 9.5 | 4.15 | 89.0 | 0 |
| 15 | 0 | — | 11.0 | 0.22 | 9.5 | 6.20 | 89.0 | 0 |
| 16 | 0 | — | 12.0 | 0.30 | 9.5 | 11.53 | 88.0 | 0 |
| 17 | 15 | 0.6 | 24.0 | 0.22 | 9.3 | 2.99 | 61.0 | 0 |
| 18 | 3 | 0.5 | 16.1 | 0.27 | 9.3 | 4.50 | 80.9 | 0 |
| 19 | 0 | — | 13.7 | 0.30 | 9.2 | 5.50 | 86.3 | 0 |
| 20 | 0 | — | 11.6 | 0.31 | 9.1 | 5.81 | 88.4 | 0 |
| 21 | 0 | — | 8.8 | 0.32 | 9.1 | 6.19 | 91.2 | 0 |
| 22 | 0 | — | 14.0 | 0.28 | 9.2 | 4.79 | 86.0 | 0 |
| 23 | 0 | — | 13.0 | 0.33 | 9.2 | 6.65 | 87.0 | 0 |
| 24 | 0 | — | 15.0 | 0.40 | 9.2 | 9.77 | 85.0 | 0 |
| 25 | 25 | 1.3 | 2.0 | nd | nd | nd | 73.0 | 0 |
| 26 | 0 | — | 1.5 | nd | nd | nd | 98.5 | 0 |
| 27 | 0 | — | 1.5 | nd | nd | nd | 98.5 | 0 |
| 28 | 0 | — | 1.0 | nd | nd | nd | 99.0 | 0 |

Underlined values: not corresponding to the invention,
nd : not determined

The phase percentages of the microstructures of the obtained cold rolled and tempered steel sheet were determined.

[C]_{A} and [Mn]_{A} corresponds to the amount of carbon and manganese in austenite, in weight percent. They are measured with both X-rays diffraction (C %) and electron probe micro-analyzer, with a Field Emission Gun (Mn %).

The surface fractions of phases in the microstructure are determined through the following method: a specimen is cut from the cold rolled and annealed steel sheet, polished and etched with a reagent known per se, to reveal the microstructure. The section is afterwards examined through scanning electron microscope, for example with a Scanning Electron Microscope with a Field Emission Gun (“FEG-SEM”) at a magnification greater than 5000×, in secondary electron mode.

The determination of the surface fraction of ferrite is performed thanks to SEM observations after Nital or Picral/Nital reagent etching.

The determination of the volume fraction of retained austenite is performed thanks to X-ray diffraction.

TABLE 6
Mechanical properties of the cold rolled,
annealed and tempered steel sheet

| | TS | UE | TE | TS × TE | YS |
|---|---|---|---|---|---|
| Trials | (MPa) | (%) | (%) | (MPa. %) | (MPa) |
| 1 | 1553 | 7.0 | 7.4 | 11492 | 827 |
| 2 | 1480 | 11.0 | 13.3 | 19684 | 1036 |
| 3 | 1488 | 10.9 | 11.6 | 17261 | 1195 |
| 4 | 1491 | 10.8 | 12.9 | 19234 | 1009 |
| 5 | 1515 | 11.2 | 13.6 | 20604 | 1187 |
| 6 | 1510 | 9.2 | 11.3 | 17063 | 1266 |
| 7 | 1535 | 8.8 | 11.2 | 17192 | 1268 |
| 8 | 1534 | 7.3 | 9.6 | 14726 | 1273 |
| 9 | 1521 | 6.8 | 9.5 | 14450 | 1212 |
| 10 | 1475 | 9.1 | 12.1 | 17848 | 1207 |
| 11 | 1501 | 8.4 | 10.4 | 15610 | 1378 |
| 12 | 1490 | 6.7 | 9.2 | 13708 | 1375 |
| 13 | 1474 | 5.8 | 8.5 | 12529 | 1347 |
| 14 | 1530 | 7.0 | 9.0 | 13770 | 1323 |
| 15 | 1484 | 6.9 | 9.3 | 13801 | 1436 |
| 16 | 1461 | 1.1 | 4.7 | 6867 | 1400 |
| 17 | 1590 | 11.0 | 13.0 | 20670 | 1310 |
| 18 | 1609 | 8.8 | 12.1 | 19469 | 1446 |
| 19 | 1628 | 7.1 | 10.1 | 16443 | 1464 |
| 20 | 1617 | 8.0 | 9.9 | 16008 | 1426 |
| 21 | 1608 | 7.6 | 9.4 | 15115 | 1414 |
| 22 | 1684 | 7.7 | 9.4 | 15830 | 1367 |
| 23 | 1588 | 7.0 | 9.0 | 14292 | 1485 |
| 24 | 1532 | 3.0 | 6.3 | 9652 | 1453 |
| 25 | 1303 | 5.0 | 8 | 10815 | 1061 |
| 26 | 1638 | 3.7 | 7.1 | 11630 | 1302 |
| 27 | 1578 | 3.1 | 6.8 | 10730 | 1324 |
| 28 | 1516 | 4.4 | 7.1 | 10764 | 1091 |

Underlined values: do not match the targeted values

Mechanical properties of the obtained cold rolled, annealed and tempered steel sheets were determined and gathered in the following table.

The yield strength YS, the tensile strength TS and the uniform and total elongation UE, TE are measured according to ISO standard ISO 6892-1, published in October 2009.

Trial 1 was not submitted to any tempering treatment. Its microstructure contains more than 5% fresh martensite which remains untempered, leading to poor total elongation value.

Trial 13 was submitted to an annealing which soaking temperature goes beyond (Ac3+50×C %/0.1). This triggers a too high value of carbon into the retained austenite, leading to uniform elongation and total elongation out of targets.

Trials 16 and 24 were submitted to a tempering step where the value of (Tₜₑₘₚₑᵣ+273)×(13+log tₜₑₘₚₑᵣ) goes beyond the maximum value. This triggers a too high value of carbon into the retained austenite, leading to uniform elongation and total elongation out of targets.

Trial 25 was submitted to a hot band annealing that is not in the intercritical domain and its composition is too low in manganese compared to the invention. The corresponding annealed hot band contains too much carbides and the manganese was not distributed in a heterogeneous way. This results in a content in residual austenite below target, decreasing the uniform elongation and total elongation. The size of ferrite grains is also out of scope, which triggers a tensile strength far below the target.

Trials 26 to 28 were done using grades that are outside of the scope of the invention in terms of composition as evidenced by table 1. In particular, their content of manganese is below 6.0 wt % and their carbon content is above 0.18%. They are also out of the scope of the invention in terms of hot band annealing parameters, as evidenced by tables 2 and 3, showing that the manganese was not distributed in a heterogeneous way, as required by the invention and that the carbide precipitation is far too high. This triggers contents of residual austenite far below the targets and to uniform elongation and total elongation below the targets.

TABLE 7
Weldability properties of the cold rolled,
annealed and tempered steel sheet

| | α | |
|---|---|---|
| Trials | (daN/mm²) | LME index |
| 1 | 40 | 0.156 |
| 2 | 40 | 0.156 |
| 3 | 40 | 0.156 |
| 4 | 38 | 0.358 |
| 5 | 38 | 0.358 |
| 6 | 38 | 0.358 |
| 7 | 38 | 0.358 |
| 8 | 38 | 0.358 |
| 9 | 38 | 0.358 |
| 10 | 50 | 0.180 |
| 11 | 50 | 0.180 |
| 12 | 50 | 0.180 |
| 13 | 50 | 0.180 |
| 14 | 50 | 0.180 |
| 15 | 50 | 0.180 |
| 16 | 50 | 0.180 |
| 17 | 37 | 0.221 |
| 18 | 37 | 0.221 |
| 19 | 37 | 0.221 |
| 20 | 37 | 0.221 |
| 21 | 37 | 0.221 |
| 22 | 37 | 0.221 |
| 23 | 37 | 0.221 |
| 24 | 37 | 0.221 |
| 25 | 85 | 0.244 |
| 26 | Nd | 0.588 |
| 27 | Nd | 0.588 |
| 28 | Nd | 0.282 |

LME index = C % + Si %/4, in wt %.
Nd: not determined

Spot welding in standard ISO 18278-2 condition was done on the cold rolled, annealed and tempered steel sheets.

In the test used, the samples are composed of two sheets of steel in the form of cross welded equivalent. A force is applied so as to break the weld point. This force, known as cross tensile Strength (CTS), is expressed in daN. It depends on the diameter of the weld point and the thickness of the metal, that is to say the thickness of the steel and the metallic coating. It makes it possible to calculate the coefficient α which is the ratio of the value of CTS on the product of the diameter of the welded point multiplied by the thickness of the substrate. This coefficient is expressed in daN/mm².

Weldability properties of the cold rolled, annealed and tempered were determined and gathered in the following table:

What is claimed is:

1-12. (canceled)

13: A cold rolled, annealed and tempered steel sheet, made of a steel having a yield strength YS above or equal to 1000 MPa, and a composition comprising, by weight percent:
C: 0.03-0.18%
Mn: 6.0-11.0%
Mo: 0.05-0.5%
B: 0.0005-0.005%
S≤0.010%
P≤0.020%
N≤0.008%
and optionally one or more of the following elements:
Al<3%
Si≤1.20%
Ti≤0.050%
Nb≤0.050%
Cr≤0.5%
V≤0.2%
a remainder of the composition being iron and unavoidable impurities resulting from processing,
the steel sheet having a microstructure comprising, in surface fraction, from 0% to 30% of ferrite, such ferrite having a grain size below 1.0 μm, from 3% to 30% of retained austenite, from 40 to 95% of tempered martensite, less than 5% of fresh martensite, and a carbon [C]_{A} and manganese [Mn]_{A} content in austenite, expressed in weight percent, such that the ratio ([C]_{A}²×[Mn]_{A})/(C %²×Mn %) is below 7.80, C % and Mn % being the nominal values in carbon and manganese in weight %.

14: The steel sheet as recited in claim 13 wherein the carbon content is from 0.05% to 0.15%.

15: The steel sheet as recited in claim 13 wherein the manganese content is from 6.0% to 9%.

16: The steel sheet as recited in claim 13 wherein the aluminium content is from 0.2% to 2.2%.

17: The steel sheet as recited in claim 13 wherein the microstructure comprises from 5% to 25% of ferrite, from 10% to 25% of retained austenite and from 50% to 85% of tempered martensite.

18: The steel sheet as recited in claim 13 wherein the microstructure comprises no ferrite, from 5% to 15% of retained austenite and from 85% to 95% of tempered martensite.

19: The steel sheet as recited in claim 13 wherein the tensile strength is above or equal to 1450 MPa, the uniform elongation UE is above or equal to 6.5% and the total elongation TE is above or equal to 9%.

20: The steel sheet as recited in claim 13 wherein TS and TE satisfy the following equation: TS×TE>13 700 MPa. %

21: The steel sheet as recited in claim 13 wherein the LME index is below 0.36.

22: The steel sheet as recited in claim 13 wherein the steel has a carbon equivalent Ceq lower than 0.4%, the carbon equivalent being defined as
Ceq=C %+Si %/55+Cr %/20+Mn %/19−Al %/18+2.2P %−3.24B %−0.133×Mn %×Mo %
with elements being expressed by weight percent.

23: A resistance spot weld of two steel parts made of the cold rolled, annealed and tempered steel sheet as recited in claim 13, the resistance spot weld having an α value of at least 30 daN/mm².

24: A press hardened and tempered steel part having a composition comprising, by weight percent:
C: 0.03-0.18%
Mn: 6.0-11.0%
Mo: 0.05-0.5%
B: 0.0005-0.005%
S≤0.010%
P≤0.020%
N≤0.008%
and optionally one or more of the following elements:
Al<3%
Si≤1.20%
Ti≤0.050%
Nb≤0.050%
Cr≤0.5%
V≤0.2%
a remainder of the composition being iron and unavoidable impurities resulting from processing, and having a microstructure comprising, in surface fraction, from 0% to 30% of ferrite, such ferrite having a grain size below 1.0 μm, from 3% to 30% of retained austenite, from 40 to 95% of tempered martensite, less than 5% of fresh martensite, and a carbon [C]_{A} and manganese [Mn]_{A} content in austenite, expressed in weight percent, such that the ratio ([C]_{A}²×[Mn]_{A})/(C %²×Mn %) is below 7.80, C % and Mn % being the nominal values in carbon and manganese in weight %.
